(19) United States
(12) Patent Application Publication
(10) Pub. No.: US 2004/0210738 A1
(43) Pub. Date: Oct. 21, 2004

(54) On-chip multiprocessor

(76) Inventors: Takeshi Kato, Akishima (JP); Michitaka Yamamoto, Machida (JP); Hiromichi Kaino, Hatano (JP); Teruhisa Shimizu, Ome (JP); Masayuki Ohayashi, Ome (JP); Hiroki Yamashita, Hachioji (JP); Noboru Masuda, Tokorozawa (JP); Tatsuya Saito, Kunitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/832,446

(22) Filed: Apr. 27, 2004

Related U.S. Application Data
(63) Continuation of application No. 09/631,628, filed on Aug. 4, 2000, now abandoned.

(30) Foreign Application Priority Data
Aug. 4, 1999 (JP) 11-221728

(51) Int. Cl. G06F 15/00

(52) U.S. Cl. 712/1

(57) ABSTRACT

An on-chip multiprocessor having a chip layout for efficient multiprocessor control, wherein multiple processors and shared portions such as shared caches are symmetric with respect to a desired linear axis and a multiprocessor controller is located in the area containing said linear axis. This makes the distances between the processors and the controller equal and shorter, and also decreases differences in the distance between the controller and shared portions, thereby permitting higher speed processing of signals among these.

### CROSS-REFERENCE TO RELATED APPLICATION

This application is a Continuation application of application Ser. No. 09/631,628, filed Aug. 4, 2000, the entire disclosure of which is hereby incorporated by reference.

### BACKGROUND OF THE INVENTION

This invention relates to an on-chip multiprocessor which has multiple independently operable processors integrated on a single chip. In addition, the invention is concerned with a chip floor plan (layout) that is optimized for on-chip multiprocessor performance enhancement.

In parallel with the increasing tendency toward ultra-miniaturization in semiconductor process technology, more and more integrated LSI chips with higher speed are being developed. As a means to enhance processor performance, while taking full advantage of this high integration technology, on-chip multiprocessors, in which multiple processors are mounted on a chip, have been proposed. There is a general concern that since the progress of LSI packaging technology has not kept up with that of semiconductor process technology, and the technological gap therebetween continues to widen, the promotion of on-chip multiprocessor systems will become more important.

Known examples of proposed on-chip multiprocessors are disclosed in the Japanese Patent Application Provisional Publication No. 61768/93 (Article 1) and U.S. Pat. No. 5,787,310 (Article 2).

Article 1 includes a functional block diagram showing multiple processors, first cache memories dedicated to the respective processors, and data switching circuitry. Here, the number of I/O pins on an LSI chip has been decreased by controlling data transfer between the multiple processors and external second cache memories through the data switching circuitry.

Article 2 shows a chip floor plan where multiple memory cell regions and multiple processors are interconnected through a bus. Here, the location of processors between memory cell regions shortens the bus wiring length, thereby increasing the processing speed and reducing the bus area.

A dual processor is disclosed in the Japanese Patent Application Provisional Publication No. 44502/95 (Article 3) in the form of a non-on-chip type multiprocessor based on chip packaging technology. Here, two processors made from plane-symmetrical mask patterns are stuck together with their rear sides in contact and integrated into a package, and the I/O pins of the two processors are connected with the package's common external bus terminal. This decreases the area of the package and the number of I/O pins used.

As a technique related to a chip floor plan, a redundant dual processor is described in the IEEE Micro, March-April, 1999, pp. 12-13 (Article 4), though it is of the single-processor type. This processor consists of instruction units (IU), fixed-point execution units (FXU), floating-point execution units (FPU), a buffer control unit (BCE) which includes a first cache, and a recovery unit (RU). To improve reliability, the IU, FXU and FPU are doubled and errors are detected by the RU. A photo of the chip as disclosed reveals that the layout patterns of the doubled units are mirror symmetric with respect to the center line of the chip.

### SUMMARY OF THE INVENTION

A major problem in on-chip multiprocessor performance enhancement is to perform efficient control between processors while ensuring independent equal operation of each processor. In other words, processes such as data transmission between processors and their controller and arbitration control should be sped up in a balanced way or equally on each processor.

Also, in order to make efficient use of shared resources such as cache memories and I/O pins mounted on a chip, the processing of signals between the controller and shared portions should be sped up. Speeding-up the interconnection among processors, shared portions the and controller largely depends on the chip layout; how their mutual distances are uniformly decreased is the key to successful speed improvement.

This invention aims to provide a chip floor plan which increases the speed and performance in multiprocessor control in an on-chip multiprocessor.

A first object of this invention is to provide a layout for multiple processors, a multiprocessor controller and shared portions as a floor plan for on-chip multiprocessor performance enhancement.

Furthermore, the invention provides layouts at the unit level, block level, circuit level or transistor level, depending on the required performance and design level.

A second object of the invention is to provide a positioning reference for an arrangement of processors, a controller and shared portions in specific terms in order to achieve the above-said first object.

A third object of the invention is to provide a layout which is suitable for a redundant dual processor in the form of an on-chip multiprocessor, which defines an inter-processor positional relationship and positional the relationship of doubled components inside the processors.

A fourth object of the invention is to provide a layout to define the positions of typical controllers and shared portions in multiprocessors, such as shared cache memories and their controllers, a I/O circuits and their controllers, global clock generator and a power supply controller.

A fifth object of the invention is to provide an arrangement of patterns of clock trees, electric wiring, I/O pins and so on according to the floor plan provided by the invention. These global patterns are an important factor that determines the chip Is basic characteristics so that they are designed at an upper design level.

A sixth object of the invention is to provide means to reduce the man-hours and cost in manufacturing an on-chip multiprocessor designed in accordance with this invention.

A seventh object of the invention is to provide circuit boards suitable for packaging the on-chip multiprocessor based on this invention, like package circuit boards and multi-chip module circuit boards.

First, various aspects of the invention will be explained, and then its various forms will be listed and explained in detail.

The first aspect of the invention involves provision of an on-chip multiprocessor having multiple independently operable processors, characterized in that at least one pair of processors among said processors are positioned symmetrically relative to each other with respect to a given linear axis or a given origin in the plane of the chip.

The term “symmetry” as used in this specification means symmetry in a plane at least at the level of units in the area of said processors. In general, there are many design levels including the unit level, block level, circuit level, and transistor level. Obviously, it is desirable to achieve the symmetries as intended by this invention at levels lower than the above-said levels as well. However, a primary object of the invention is to achieve symmetry in the plane at least at the unit level.

Symmetry may be a linear symmetry or a point symmetry (rotation by 180 degrees). In either case, it is possible to achieve the primary object of the invention. Further, in a special form, for instance, for an on-chip multiprocessor with four processors on a chip, rotation by 90 degrees can be used. In addition, the primary object can be achieved by a translation in planar arrangement having a linear symmetry or point symmetry such as mentioned above. These symmetry variations will be detailed later. Here, translation is movement of an object in a direction parallel to said linear axis or, in the case of point symmetry, in a direction parallel to the centerline in the area of two symmetrically arranged processors. Translation as mentioned above may be possible in case of rotation by 90 degrees and be effective similarly. The range of translation is usually around 25 percent of the machine cycle of the processors concerned. The smaller the range of translation is, the better will be the primary object that can be achieved. Translation of below 20% of the machine cycle is even more preferable. In any case, such translation offers more facility in designing various on-chip multiprocessors and increases the design tolerance.

The second aspect of the invention involves the provision of an on-chip multiprocessor having multiple independently operable processors, characterized in that at least one pair of processors among said processors are positioned symmetrically relative to each other with respect to a given linear axis or a given origin in the plane of the chip, and the controller for said pair of processors is located in the area containing said linear axis or origin.

The second aspect involves the first aspect plus the idea about the location of the controller for the pair of processors. That the controller is located in the area containing said linear axis or origin can make delays in transmission between them substantially equal.

Therefore, the invention's third aspect involves the provision of an on-chip multiprocessor having multiple independently operable processors, characterized in that at least one pair of processors among said processors are positioned symmetrically relative to each other with respect to a given linear axis or a given origin in the plane of the chip, and that delays in signal transmission from the controller for said pair of processors to both the processors are substantially equal. The permissible delay time difference range varies depending on the on-chip multiprocessor design specification. In practical applications, delays of below 25 percent, more preferably 20 percent, of the machine cycle time are often used.

That delays from the controller to both the processors are substantially equal implies that the distances from the controller to them are almost the same. Specifically, due to the positions of the pins inside the controller or the like, the distance between the first processor and the controller may be slightly different from the distance between the second processor and the controller. Practically, however, taking into account the controller's size proportion in current on-chip multiprocessors, it may be considered that the distances are almost the same.

The fourth aspect of the invention involves the provision of an on-chip multiprocessor having multiple independently operable processors, characterized in that at least one pair of processes among said processors are positioned symmetrically relative to each other with respect to a given linear axis or a given origin in the plane of the chip, that the controller for said pair of processors is located in the area containing said linear axis or origin, and that the distances from the controller to both the processors are substantially equal.

The fifth aspect of the invention involves the provision of an on-chip multiprocessor having multiple independently operable processors, characterized in that at least one pair of processors among said processors are positioned symmetrically relative to each other with respect to a given linear axis or a given origin in the plane of the chip, that delays in signal transmission from the controller for said pair of processors to both the processors are substantially equal, and that the shared portions connected through the controller to said pair of processors are located in the area containing said linear axis or origin. Also, it is preferable that said shared portions are located almost symmetrically with respect to said linear axis or origin. This can minimize the delay time difference in question. Here, the shared portions are, for example, shared cache memories or I/O means.

The invention's main forms have been outlined above. Descriptions of the invention in various forms will be given in connection with the above-said objects.

In order to achieve the above first object, the on-chip multiprocessor according to the invention uses means to locate multiple processors symmetrically relative to each other with respect to a virtual positioning reference (linear axis or origin) in the chip plane and to locate the multiprocessor controller in the area containing this positioning reference and, if there are any shared portions, to locate them almost symmetrically with respect to the positioning reference. This makes the controller lie almost at the midpoint between the processors, so that the distances from the controller to the processors are substantially equalized and shortened.

Also, the differences in distance from the controller to the shared portions are reduced and leveled. Depending on timing design and the required semiconductor process yield rate, symmetry in layout is pursued at lower design levels. Whether to use symmetry in layout or not can be chosen, regarding, for instance, logical units and cache memories, logical blocks and memory mats, logical/memory circuit groups, circuit cells, transistors, and transistor components (sources, gates and drains in case of MOS transistors).

When performing symmetric transformation at the transistor level, a means to reduce the influence of semiconductor process variation is needed one approach is that in the transistor structure, both a source and a drain are provided at both sides of one gate in a MOS transistor or that both a gate and a source are provided at both sides of one drain. This may be a kind of micro symmetric structure. This micro symmetric structure offsets the influence of positional discrepancy with respect to the gate length direction, resulting in symmetrically transformed transistors in the processor having the same characteristics.

A means to achieve the above second object involves the use of a gate direction as a positioning reference in designing chips with MOS transistor circuitry. The processors and controller/shared portions are arranged on the chip symmetrically with respect to a linear axis parallel or perpendicular to the gate direction, or point-symmetrically with respect to a virtual origin (rotation by 180 degrees) This leads to parallel gate orientation, thereby reducing the influence of semiconductor process variation.

Another means for achieving the above second object is to use the direction of data flow in data system logic as a positioning reference, depending on the logical structure, to define symmetry in layout as mentioned above. This permits data from the processors to flow in parallel to each other without intersecting at right angles, facilitating data exchange with the multiprocessor controller. For instance, in arithmetic processing, since data flows from the upstream to the downstream, data flows can be made smoother by locating the multiprocessor controller, including the cache control unit and interface control unit, upstream of both the processors. If the data flows are parallel, the directions of transistor input/output lines are uniform, which reduces transistor characteristic fluctuations, whether the transistor type is MOS, BiCMOS or bipolar.

A means for achieving the above third object is to position the multiple processors symmetrically with respect to a first linear axis, position the multiprocessor controller in the area containing the first linear axis and position the redundant dual logical units or cache memories inside the processor symmetrically with respect to the second linear axis. This meets both the following requirements: the distance between each of the processors and the multiprocessor controller should be equal, and the distance uniformity in the dual and single sections inside the processors should be ensured.

In implementation of the above third means, if the single section controlling the dual section is located around the midpoint of one side of the processor area, for the single section and multiprocessor controller to come closer, it is desirable that the first linear axis and the second linear axis intersect at right angles. Regarding the choice between the gate length direction and the gate width direction for the symmetry axis, if the former is chosen, the influence of semiconductor process variation will be less. Generally, more strictness is required in intra-processor timing design than inter-processor timing design, so it is more effective to use the gate length direction for the second linear axis. It is desirable that data between the dual sections flows in the same direction (if data flows are parallel and the direction of flow is reversed alternately, control inside the processor would be difficult), so it is more effective to use the second linear axis for the direction of data flow.

A means for achieving the above fourth object is specific arrangement of the multiprocessor controller/shared portions based on the above-mentioned means. When a cache memory is shared by the processors, the storage control unit for data transmission and adjustment among the processors, shared cache, external memory and so on is positioned in the area containing the positioning reference, as stated in the description of the above first means. For performance enhancement of a multiprocessor using a connection through bus, as disclosed in Article 2, or using network connection, as disclosed in Article 3, it is preferable to connect one processor with one storage control unit. If each processor has its own first cache, the shared cache serves as a lower level cache, or the 1.5th or second cache (the 1.5th cache can be accessed simultaneously with the first cache but it requires more latency time than the first cache). In this case, performance can be enhanced by placing the first cache control unit near the positioning reference inside each processor and inserting the storage control unit between the first cache control units.

In the above fourth means, for the I/O circuits to be shared, the I/O control unit for signal transmission and priority control is positioned as in the above case. Sharing of the I/O circuits reduces the required number of I/O pins. Depending on the interface specification, the I/O control unit controls one-to-one transmission, bidirectional transmission, bus connection, network communication or the like. A more preferable arrangement is that the I/O control unit present in each processor is placed near one side of the processor area at the positioning reference side and the multiprocessor I/O control unit is placed between the units inside the processors.

A further means for achieving the fourth object is to place the global clock generator circuit (PLL, initial-level clock driver, etc.) or the power supply controller (low power/test mode control, substrate bias control, etc.) in the area containing the positioning reference. This uniformly supplies clock signals to multiple processors for the global clock generator or permits balanced power supply control for the power supply controller. Also, the fourth means is suitable for adjusting and stopping clock signals and power supplies separately for each of the processors, controller and shared portions.

A means for achieving the fifth object is to make symmetric transformation of the global pattern for each of the clock tree, electric wiring, I/O pins and other parts concerned, in line with the processor symmetry achieved by the above means. This enables clock distribution to each processor with an equal skew. By giving the processors priority over the multiprocessor controller/shared portions in supply of clock signals, skews inside each processor can be reduced with a resultant speed increase.

Here, symmetry in the clock tree with respect to the linear axis or origin is sufficient to achieve the primary object so long as the basic tree structure has this symmetry. In the clock tree structure, the global level may be a relatively high layer wiring level, in case of H trees, for example, the third or fourth level from the first level of “H.” On the other hand, the local level may be a relatively low-layer wiring level. Although there can be local a disturbance in symmetry in this structure in actual design, the basic concept of this invention is to introduce this symmetry into the basic tree structure. In this invention, symmetry in the upper levels of the clock tree in the processor area is particularly important. However, needless to say, it is more desirable to ensure symmetry the in lower levels of the tree structure as well.

In terms of electric wiring, the processors' electrical characteristics such as voltage drop and noise become uniform and the need to make noise checks and timing analyses for each processor is eliminated, contributing to reduction in man-hours. In case bumps are provided on the surface of the chip as I/O pins, the number and arrangement of bumps for power supply/grounding are maintained depending on the processor symmetry, so that the electric characteristics are made uniform as in the above case of electric wiring.

A means for achieving the sixth object is that in manufacturing an on-chip multiprocessor using the above-mentioned means in the semiconductor process, the mask pattern for a given processor area is taken as a master pattern and the mask pattern produced by symmetric transformation of this master pattern is used for other processor areas. This eliminates the need to produce or adjust the mask pattern for each processor. This technique is applicable to master patterns used to form transistor circuits, device circuits and processor internal wiring in order to reduce the cost and man-hours involved in mask pattern generation.

A means for achieving the seventh object is that in mounting an on-chip multiprocessor based on the above-mentioned means on a package substrate, multi-chip module substrate or the like, the same symmetric transformation as made on the processors is made for the substrate wiring pattern. This not only maintains uniformity in electrical characteristics as mentioned above for the sixth means but also can reduce design man-hours involved in wiring pattern generation.

### BRIEF DESCRIPTION OF THE DRAWINGS

Other objects and advantages of the invention will become apparent during the following discussion of the accompanying drawings, wherein:

FIG. 1 is a diagram of a floor plan showing the chip layout in an on-chip multiprocessor representing a first embodiment of this invention;

FIG. 2 is a functional block diagram of the first embodiment;

FIG. 3 is a diagram which shows the layout of the logical blocks inside the logical units in the first embodiment;

FIG. 4 is a diagram which shows arrangements of MOS transistor circuits inside the logical blocks in the first embodiment;

FIG. 5 is a diagram which shows the arrangements of MOS transistor circuits in a second embodiment of this invention;

FIG. 6A is a diagram which shows the layout of the clock tree of an on-chip multiprocessor according to a third embodiment of this invention;

FIG. 6B is a diagram which shows the arrangement of electric wiring of an on-chip multiprocessor according to the third embodiment of this invention;

FIG. 6C is a diagram which shows the arrangement of the I/O pins of an on-chip multiprocessor according to the third embodiment of this invention;

FIG. 7 is a diagram of a floor plan for an on-chip multiprocessor according to a fourth embodiment of this invention;

FIG. 8 is a diagram of a floor plan for an on-chip multiprocessor according to a fifth embodiment of this invention;

FIG. 9 is a diagram of a floor plan for an on-chip multiprocessor according to a sixth embodiment of this invention;

FIG. 10 is a diagram of a floor plan for an on-chip multiprocessor according to a seventh embodiment of this invention;

FIG. 11 is a diagram which shows the layout of a multi-chip module circuit board packaged with an on-chip multiprocessor according to an eighth embodiment of this invention; and

FIGS. 12, 13 and 14 are diagrams which show processor pair layout patterns by type.

### DETAILED DESCRIPTION OF THE PREFERRED EMBODIMENTS

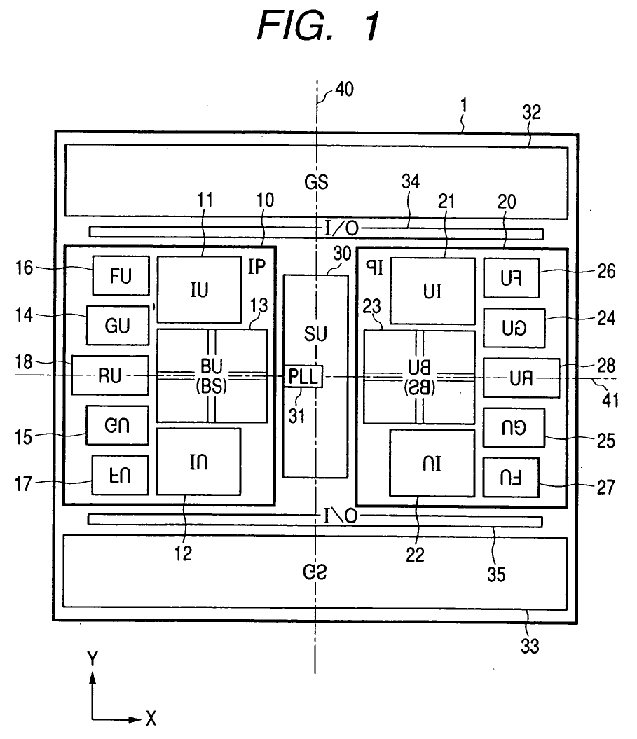

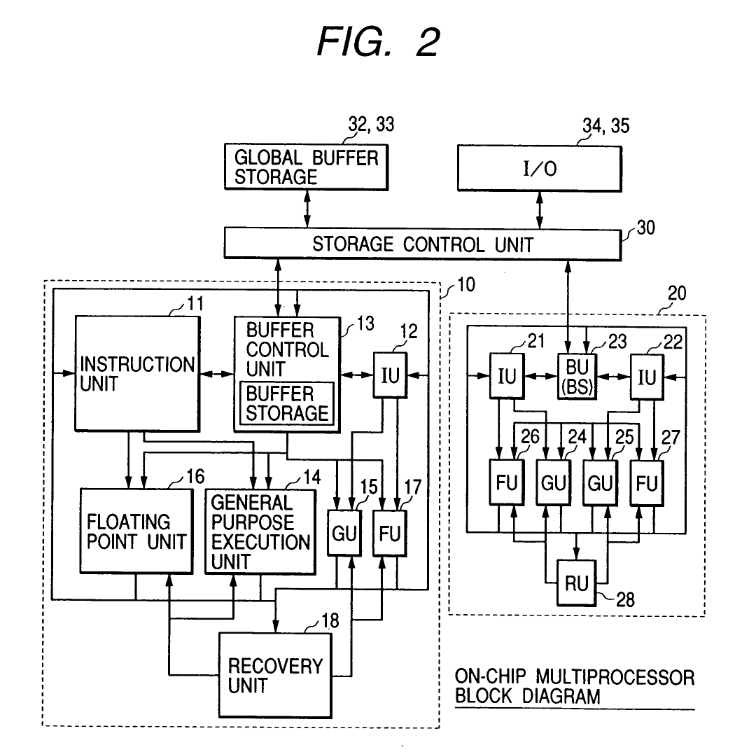

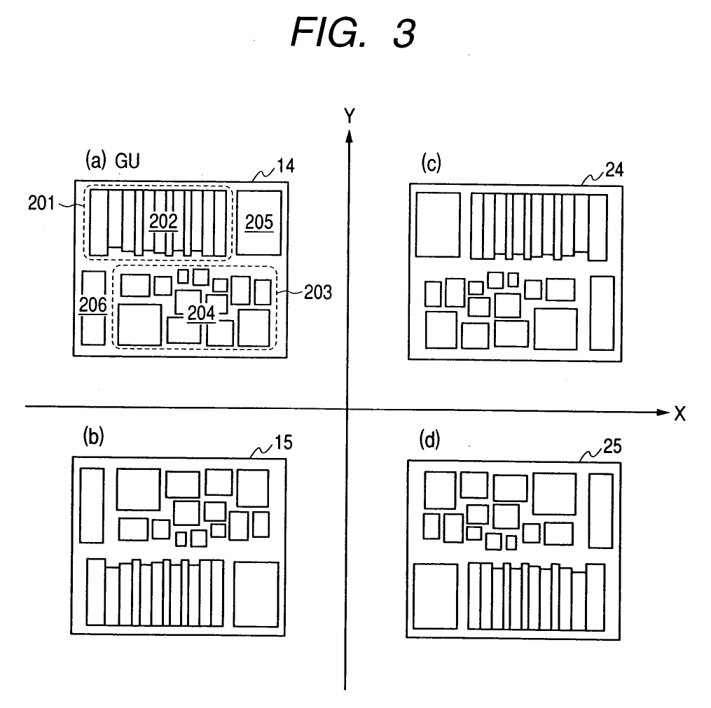

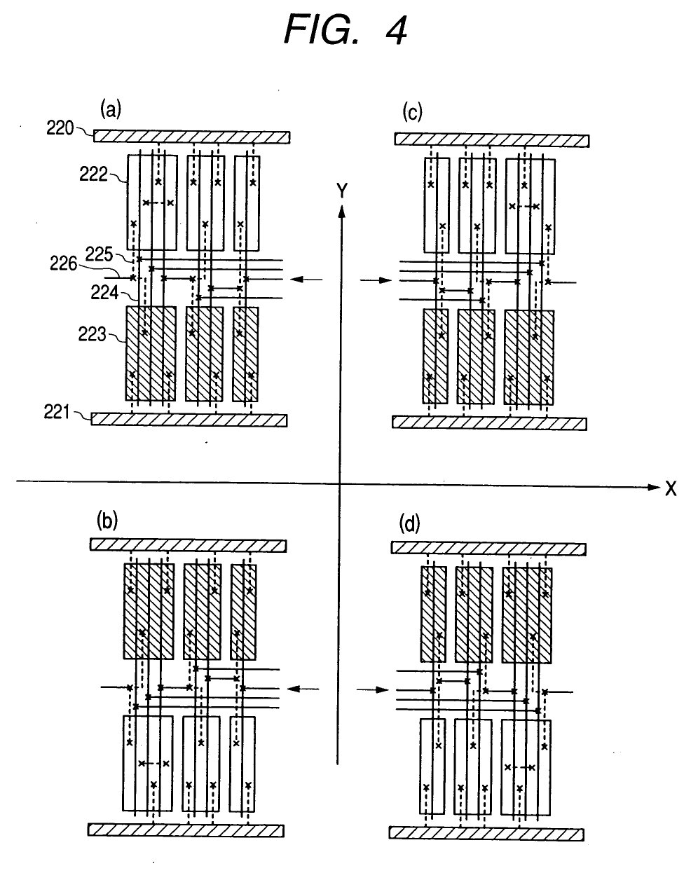

As the first embodiment of this invention, an on-chip multiprocessor in which two processors (dual processor) are mounted on a chip and the internal components are doubled in each processor will be explained. FIGS. 1 and 2 are a floor plan and a functional block diagram, respectively, for the on-chip multiprocessor representing the first embodiment. In FIG. 1, abbreviations (FU, GU, etc.) on the right half of the figure are intentionally inverted or rotated to indicate layout symmetry. The parts with inverted abbreviations indicate that their geometric planar configurations are inverted. The X/Y coordinate axes shown at the left bottom of FIG. 1 will be explained later in connection with FIGS. 3 and 4.

In the examples shown in FIGS. 1 and 2, on-chip multiprocessor 1 is composed of: independently operable instruction processors (IP) 10 and 20; a storage control unit (SU) 30 which controls storage between the processors and I/O interfacing; global buffer storages (GS, 1.5th caches) 32 and 33 which are shared by the processors through SU30; I/O circuit groups (1/0) 34 and 35; and a clock generator (PLL) 31. This dual processor 1, which has been manufactured by the 0.13 μm-generation process called the CMOS process, operates at a clock frequency of 1.2 GHz. Approx. 250M transistors are integrated in a chip of approx. 17 mm square, and the capacities of buffer storages (BS, first caches) in IP10 and 20, and those of GS32 and 33 are 256 KB×2 and 2 MB, respectively. I/O circuit groups 34 and 35 each consist of a circuit cell array where I/O circuit cells are arranged in a striped pattern with approx. 1000 I/O pins in total.

IP10 is composed of: instruction units (IU) 11 and 12 for instruction fetching, decoding, address generation and branch estimation; a buffer control unit (BU) 13 for reading/writing of instruction words and data for buffer storage and storage control; general-purpose execution units (GU) 14 and 15 for executing fixed-point and logical arithmetic instructions; floating point units (FU) 16 and 17 for executing floating point arithmetic instructions; and a recovery unit (RU) 18 for calculation error detection and recovery. The configuration of IP10 is shown in FIG. 2. It has a dual structure which incorporates two IUs (11, 12), two GUs (14, 15) and two FUs (16, 17). The RU18 compares processing results from the two systems. Like IP10, IP20 is composed of IU21, 22, BU23, GU24, 25, FU26, 27 and RU28.

Next, according to the first embodiment, the characteristic points of the invention will be explained with reference to FIG. 1. Instruction processors IP10 and IP20 are positioned symmetrically with respect to a virtual linear axis 40. Storage control unit SU30 is located in the area containing the linear axis 40.

Inside instruction processors IP10 and 20, instruction units IU11 and 21, instruction units 12 and 22, buffer control units BU13 and 23, general-purpose execution units GU14 and 24, general-purpose execution units GU15 and 25, floating point units 16 and 26, floating point units FU17 and 27, and recovery units RU18 and 28, which all constitute pairs, are positioned symmetrically with respect to said linear axis 40, respectively.

Besides, BU13 and BU23 are located at one side of each area of IP10 and IP20 nearer to the linear axis 40, respectively.

This consideration in layout makes it possible that SU30, which is in charge of storage control, is adjacent to BU13 and BU23 with an equal distance from it to each of them, so that timing can be designed to ensure uniformity in operation and reduce delay times for higher speed control.

According to layout redefinition from the viewpoint of delays, it may be said that SU30 lies in the area containing the intersection of equal delay lines originating in the centers of BU13 and BU23.

Taking into consideration trade-offs with the degree of integration or wiring material volume, practically, signal transmission delay on the chip may take tens of picoseconds/mm even if a high speed wiring system is used. In a GHz class processor whose machine cycle is below 1000 ps/mm, as in the first embodiment, the machine cycle depends on on-chip layout and distances so floor planning as suggested by this invention is extremely effective.

The shared caches GS32 and 33 and shared I/034 and 35 for IP10 and IP20 are almost symmetrically positioned with respect to linear axis 40 and also with respect to linear axis 41. Linear axis 41 is perpendicular to linear axis 40. Therefore, the wiring from SU30, located in the area containing linear axis 40, to GS32 and 33, and to I/034 and 3 5 are symmetric, respectively, so delay differences can be eliminated or delays can be equalized. This enables the processors to use these shared portions equally.

As dual units, IU11 and 12, IU21 and 22, GU14 and 15, GU24 and 25, FU16 and 17, and FU26 and 27 are positioned symmetrically with respect to linear axis 41, respectively. This equalizes the distances between the dual units and single units, BU13 and 23, and RU18 and 28, enabling data transmission between the dual and single units with uniformity in timing.

Although in the first embodiment, the symmetry axis for IP10 and IP20, 40, and that for the dual units, 41, are perpendicular to each other, this is merely one example in accordance with the invention. Unlike the first embodiment, if it is assumed that the two IPs are positioned symmetrically with respect to an axis parallel to the symmetry axis for the dual units, 41, the two IUs would have to be placed between the BUs and, thus, the distance from each BU to the SU would be longer, resulting in a longer delay. If the positions of the BUs and IUs are changed to make the BUs closer to each other, positional imbalance would occur between the dual unit and BU inside each IP, which might unfavorably affect the dual unit timing design. It is, therefore, not a good idea to make the symmetry axis for the IPs and that for the dual units parallel to each other, and it is important for these axes to be perpendicular to each other as in the first embodiment.

Clock signals generated by PLL31 as a clock source are supplied to the inside of chip 1 through the clock distribution wiring such as H trees, fishbone or mesh laid along linear axis 40 or 41 and the clock driver since like SU30, PLL31 lies in the area containing linear axis 40, the distances from PLL31 to IP10 and to IP20 are the same and clock signals can be supplied to the IPs with uniform clock skew. This means that there is no need to use different timing design references for IP10 and IP20. The speed of IP10 and IP20 can be increased by making preferential clock distribution wiring to IP10 and IP20 from PLL31 to reduce skewing. Also, if clock signals are supplied to IP10 and IP20 independently, the arrangement as proposed by this invention will be desirable in terms of uniformity. This applies not only to clock signals but also to the power supply control circuit.

Hence, the floor plan in the first embodiment ensures that instruction processors IP10 and IP20 can run independently and equally and also that control between these processors and shared caches GS32 and GS33, and shared I/034 and I035 can be done efficiently at high speed through storage control unit SU30. In addition to multiprocessor control, it ensures that the redundant dual units inside IP10 and IP20 run at equal timings, which is very important for inter- and intra-processor performance and reliability improvement. These effects of the first embodiment can be obtained by adoption of the means described in the first embodiment, not simply by chip layout as shown in the functional block diagram of FIG. 2.

FIG. 3 is an enlarged view of schematic layout patterns of general-purpose execution units GU14, 15, 24 and 25 as examples of block arrangements inside the logical units of the first embodiment. Arrangements of lower level blocks in the general-purpose execution units are schematically shown here. In FIG. 3, (a), (b), (c) and (d) represent enlarged layout diagrams for general-purpose execution units GU14, 15, 24 and 25, respectively. In FIG. 3, the directions of X and Y axes correspond to those of the coordinate axes in FIG. 1 and the four GUs are allocated to the four quadrants in this coordinate system. Here, GU14 and 15 (which constitute a dual unit) are symmetric with respect to the X-axis (linear axis 41 in FIG. 1) and so are GU24 and 25 (which also constitute a dual unit). GU14 and GU24, and GU15 and 25, the relation of which corresponds to that of IP10 and IP20, are symmetric with respect to the Y axis (linear axis 40 in FIG. 1). GU14 and GU25 are point-symmetric (rotation by 180 degrees) with respect to the coordinate origin (i.e. intersection of linear axes 40 and 41) and so are GU15 and GU24.

In FIG. 3, GU14 is composed of a data system logical section 201, a control system logical section 203 and registers 205 and 206. The data system logical section 201 consists of a block group 202 while the control system logical section 203 consists of a block group 204. Block groups 202 and 204 are so arranged that in data system logical section 201, data flows from the right to the left in the figure (−X direction). GU15, GU24 and GU25 are the same in composition as GU14, except that the same functional components of the four GUs are symmetric with respect to linear axes 40 and 41. Therefore, the directions of data flow in GU15, 24 and 25 are −X, X and X, respectively.

When data flows in this way, the data flow upstream side of GU14 and 15 is opposite to that of GU24 and 25. In the first embodiment, the BUs and SU are positioned upstream of the GUs, so that data flows with SU30 as the source as follows: GU14, 15→BU13→SU30→BU23→GU24, 25. This allows efficient and high speed multiprocessor control. In addition, data flows in the same direction in GU14 and 15 as a dual unit and so does it in GU24 and 25 as a dual unit, which makes control of data between the GUs and BU inside each processor more efficient than when data flows in opposite directions.

FIG. 4 is an enlarged partial view of FIG. 3 to show arrangement examples of transistor circuits in the logical blocks of the above first embodiment. In FIG. 4, (a) to (d) correspond to general-purpose execution units (a) to (d) in FIG. 3. For better illustration, transistor circuits are shown in schematic form. In FIG. 4, the directions of the X and Y axes correspond to those in FIGS. 1 and 3, and the X axis is parallel to the linear axis 41 in FIG. 1 and the Y axis is parallel to the linear axis 40 in FIG. 1. As stated above, the four quadrants in FIG. 4 correspond to those in FIG. 3, where (a) (b), (c) and (d) have the same nature of symmetry as GU14, 15, 24 and 25, respectively. In FIG. 4, the smaller arrows represent the directions in which signals are sent to transistor circuits.

The transistor circuit group as shown in FIG. 4 consists of CMOS circuit cells, and as an example, inverter, 2 input NAND and 2-1 input AOI circuits are included here. Each circuit cell is composed of p-MOS transistor 222, n-MOS transistor 223, gate 224, power supply wirings 220 and 221, cell wiring 225 and signal wiring 226. In transistors 222 and 223, the parts connected to power supply wirings 220 and 221 are sources and the parts connected to the output of each circuit cell are drains. For these circuit elements, the gate length direction is parallel to the X axis, or symmetry axis 41 for each dual unit, while the gate width direction is parallel to the Y axis, or symmetry axis 40 for IP10 and IP20.

The reason for the choice of this arrangement is that in the first embodiment, the inner timing design in each instruction processor IP requires more strictness than inter-processor timing design. Fluctuations in transistor characteristics due to semiconductor manufacturing process variation are larger in gate positional deviation from the p- or n-well in the gate length direction than in the gate width direction. Therefore, the transistor arrangement as shown in FIG. 4 is used to reduce characteristics fluctuations in the dual circuit group in each IP ((a) and (b), and (c) and (d)). In short, the processor speed can be increased by properly selecting the relationship of symmetry axes and gate length/width directions in chip floor planning.

In the first embodiment, taking into account variations in the gate exposure/drafting process, the layout symmetry is limited to a linear symmetry with respect to a linear axis parallel to either the gate length direction or gate width direction or a point symmetry (180° rotation) like the relationship between (a) and (d) and between (b) and (c).

Other types of symmetry such as symmetry with respect to a 45° rotated axis, 90° rotation and combination of translation and linear symmetric transformation may be options for this invention; the choice should be made from a comprehensive viewpoint taking into consideration the following factors: the number of processors on a chip, performance requirement, and transistor characteristics, integration and yield rates achieved by currently available semiconductor process technology.

In the transistor circuit arrangement as shown in FIG. 4, the directions of signal transmission (indicated by the smaller arrows in the figure) correspond to the directions of data flows as in the description of FIG. 3. This means that both inter-processor control efficiency improvement (the effect as shown in FIG. 3) and intra-processor speed increase due to minimized semiconductor process variation (the effect as shown in FIG. 4) can be achieved at the same time.

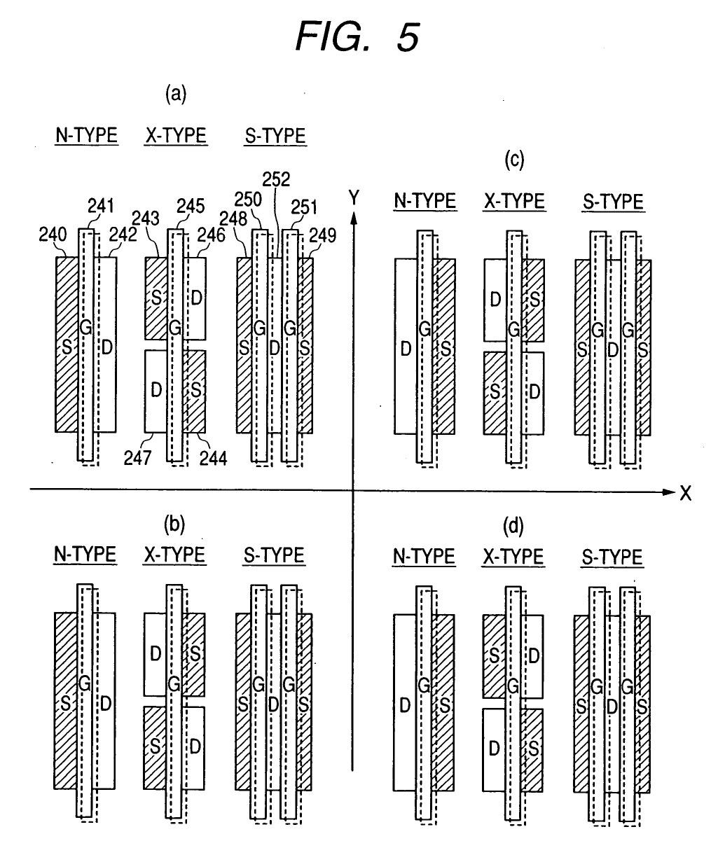

FIG. 5 is a schematic layout diagram to show MOS transistors in the second embodiment of this invention. As means to minimize the influence of semiconductor process variation in symmetric transformation at the MOS transistor circuit level according to this invention, positional/directional reference in symmetric transformation suitable for circuit orientation has been explained referring to FIG. 4. In connection with the second embodiment, as shown in FIG. 5, symmetry concerning internal elements of MOS transistors will be explained. In FIG. 5, X and Y axes and four quadrants (a) to (d) correspond to those in FIG. 4. Quadrants (a) and (b) are symmetric with respect to X axis, quadrants (a) and (c) are symmetric with respect to Y axis and quadrants (a) and (d) are point-symmetric (180° rotation). Quadrants (a) and (b) or (c) and (d) constitute a dual unit in one processor.

FIG. 5 shows three types of MOS transistors in (a) to (d). N-type represents ordinary transistors while X-type and S-type are transistors based on this invention. Taking (a) in FIG. 5 as an example, the N-type comprises a source (S) 240, a gate (G) 241 and a drain (D) 242. The X-type has a source 243 and a drain 247 on the left of gate 245, and a drain 246 and a source 244 on the right of the gate such in a way that they are arranged symmetrically with respect to the center point inside the transistor. The S-type has a drain 252 sandwiched between gates 250 and 251 and sources 248 and 249 so that it is characterized by mirror symmetry with respect to drain 252.

In FIG. 5, the gates are double-framed for the purpose of indicating a relative gate offset (toward the right bottom in the figure) with respect to the well (drain and source) due to semiconductor process variation. In FIG. 5 (a) , the N-type has a wider source 240 and a narrower drain 242; the range of offset in (b) parallels that in (a) so transistor characteristics in (a) and (b) are the same. On the other hand, the N-type in (c) and (d) has a wider drain and a narrower source unlike (a) and (b); so their characteristics are different from those of (a) and (b).

The X-type has two source/drain pairs where the two drains (sources) are diagonally positioned relative to each other. Therefore, if the source and drain on one side become wider, the source and drain on the other side become narrower. The same thing can occur in each symmetric transformation in (a) to (d) in FIG. 5, so that the X type transistors in (a) to (d) have the same characteristics. In the S-type, the width of the drain between the gates is constant so that the S-type transistors in (a) to (d) have the same characteristics.

As can be seen from the above explanation, the X-type and S-type transistors in the second embodiment have the effect of equalizing the transistor characteristics concerning symmetric transformation in this invention. In comparison with the N-type, the X-type is slightly complex in its structure and the S-type has the drawback of area increase, so it is advisable to selectively use these types in cases that characteristics uniformity between processors is particularly important, for example, in clock drivers, flip-flop/latch circuits, RAM clock inputs and RAM sense amplifiers.

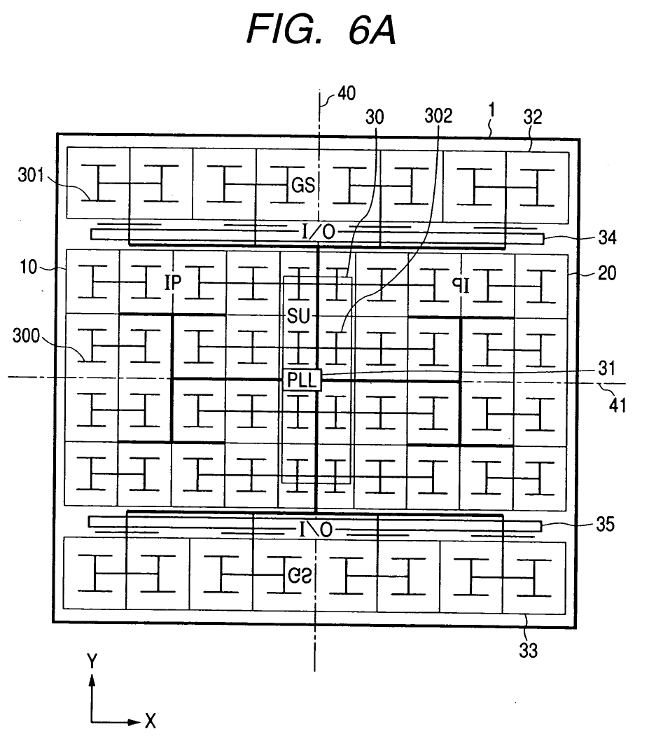

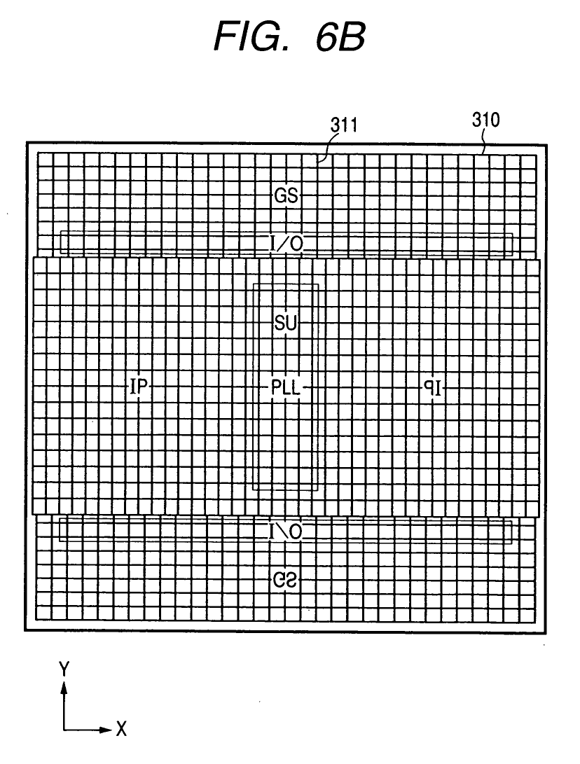

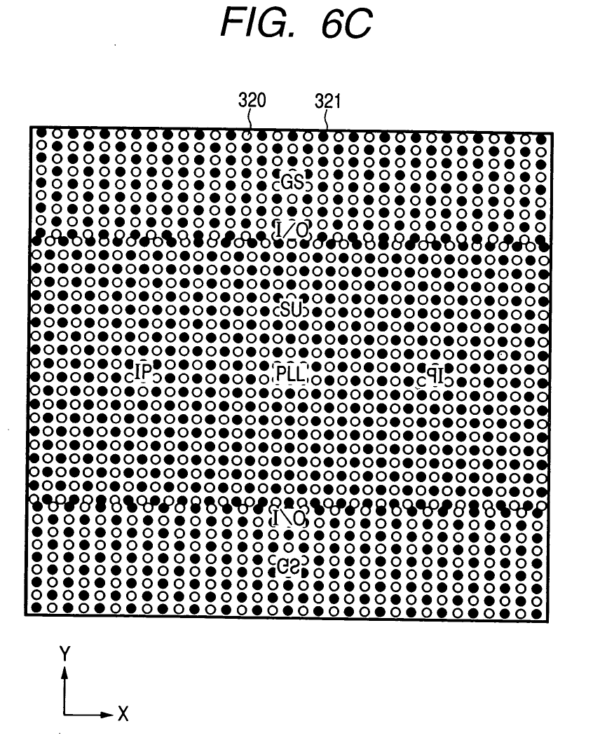

FIGS. 6A, 6B and 6C illustrate the clock tree, power supply wiring and I/O pin rough layout in the third embodiment of the invention, respectively. Symmetric transformation of these global patterns based on symmetry in the multiprocessor and its controller will be described next, taking the on-chip multiprocessor as shown in the first embodiment as an example.

The clock distribution tree in FIG. 6A is composed of H trees 300 which distribute clock signals to IP10 and IP20, deformed trees 301 for GS32, 33 and I/034 and 35, and deformed trees 302 for SU30. Instead of using the same tree type for clock distribution throughout the chip, preferential short wiring connection from PLL31 to IP10 and IP20 is made to reduce clock skews.

H trees 300 are symmetrically positioned with respect to linear axis 40 as the reference for symmetric transformation of IP10 and IP20, and the pattern of the H trees is also symmetric with respect to the symmetry axis 41 for the dual units in the IPs. Therefore, clock signals can be supplied to the dual units of both IP10 and IP20 with uniformity in skews so that it is unnecessary to make timing design separately.

In parallel with symmetry of GS32 and 33 shared by IP10 and IP20 and symmetry of shared I/034 and 35, trees 301 are symmetric with respect to linear axes 40 and 41. The illustration shows an upper tree part and a lower one; the 301 trees can be considered as a variation of H tree or fish-bone type. Tree 302 is formed by connecting tree s made of branches from the H trees 300 on both sides above SU31. In the third embodiment, because of preferential clock supply to the IPs, clock phases between the H trees 300 and trees 301 or 302 are different; this difference can be positively used in timing design for the multiprocessor controller/shared portions.

FIG. 6B shows an upper-layer power supply wiring pattern in multilayer wiring, where wires in the X-axis direction and ones in the Y-axis direction constitute a mesh pattern. The mesh pattern above IP10, 20 and SU31 and that above GS32, 33, I/034 and 35 are used selectively taking into consideration such factors as DC drop and switching noise. The former pattern is linearly symmetric so as to follow IP symmetry, so that equal electric characteristics can be ensured for both IPs and power supply design common to IPs and SU can be used, leading to a decrease in man-hours in design work. The latter pattern is designed to meet power supply design criteria for specific circuits such as RAM and I/O circuits.

FIG. 6C shows the arrangement of bumps as I/O pins. In order to pick up many I/O pins, not the peripheral I/O system but the bump array system is used here. In the figure, white dots 320 represent bumps for signals connected to I/034 and 35, while black dots 321 represent bumps for power supply/grounding connected to the power supply wiring. The bump arrangements above IP10, 20 and SU31, above GS32 and 33, and above I/03 4 and 35 are different taking into account power consumption. In regions with signal bumps, the ratio of signal pins to power supply pins is 1, while in regions without signal bumps (non-dual parts in the IPs such as BU13, 23, RU18 and 28, or above PLL31, I/034 and 35, etc), the number of power supply pins is larger. The bump arrangement above IP10, 20 and SU31 is linearly symmetric as in the power supply wiring, permitting equal power supply to both IPs.

As explained above, the third embodiment permits suitable clock distribution and power supply for symmetry in the multiprocessor and its controller/shared portions based on this invention, and also enables use of common design for multiple processors, contributing to reduction in design work man-hours.

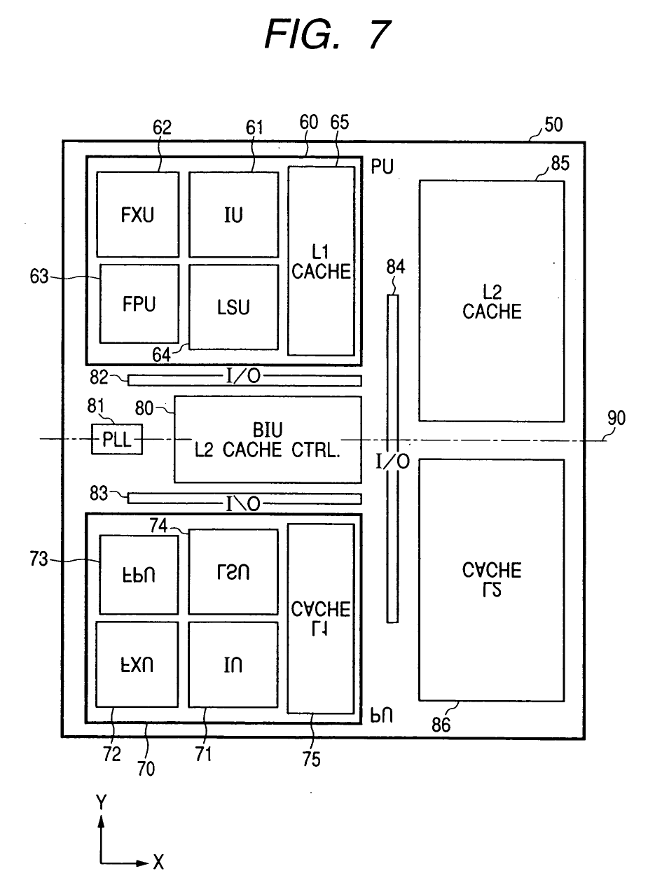

So far the first embodiment has been explained and also the second and third embodiments have been described in connection with the first embodiment. The fourth embodiment concerns an on-chip multiprocessor where two RISC microprocessors are mounted on a chip. FIG. 7 is the floor plan for the fourth embodiment. The X and Y axes in the left bottom of FIG. 7 represent the gate length direction and the gate width direction, respectively, as in the first embodiment.

As shown in FIG. 7, the on-chip multiprocessor 50 is composed of processor units (PU) 60 and 70 (for instance, RISC processors), a bus interface unit (BIU) 80 for storage control between PU60 and 70 and external bus interface control, second caches 85 and 86 shared by the PUs via BIU80, internal striped I/O circuit arrays 82 to 84 shared in the same way, and a clock generator (PLL) 81. This processor 50 has been manufactured by the 0.12 μm generation CMOS process used the first embodiment and its general specification is as follows: 1.25 GHz internal operating frequency, approx. 14 mm square chip size, approx. 150M transistors, two 128 KB first caches, IMB second caches and approx. 500 I/O pins. The internal clock is uniformly distributed from PLL81 to PU60, 70, SU80 and second caches 85 and 86. The I/O frequency is selectively divided according to the specification of the external bus.

Processor unit PU60 is mainly composed of an instruction unit (IU) 61 for instruction parallel dispatch, f etch and branch estimation, a fixed-point unit (FXU) 62 f or parallel execution of arithmetic instructions, a floating-point unit (FPU) 63 for single accuracy/double accuracy calculation, and a load/store unit (LSU) 64 which accesses and manages the first cache 65 storing instruction words and data. Like PU60, PU70 is composed of IU71, FXU72, FPU73, LSU74 and a first cache 75.

In the fourth embodiment, processor units PU60 and 70 are symmetric with respect to a virtual linear axis 90 and the second caches 85 and 86 shared by PU60 and 70 are also symmetric with respect to the axis 90. The BIU that controls these shared portions is positioned in the area containing linear axis 90 and LSU64 in PU60 and LSU74 in PU70 are each situated at the side of axis 90, or near one side of BIU80. Thus, in the fourth embodiment, the distance from BIU80 to LSU64 and that to LSU74 are equal and BIU80 and LSU64 or 74 are near to each other, and second caches 85 and 86, I/082 to 84 and BIU80 have a balanced positional relationship, so that high speed microprocessor control can be made without priority being given to one processor over the other.

In the fourth embodiment, it is unnecessary to consider priority in symmetric transformation concerning dual units and processors since inside the PUs there are no dual units as seen in the first embodiment. Therefore, the symmetry axis 90 for PU60 and 70 is made parallel to the gate length direction, minimizing characteristics fluctuation between the PUs due to semiconductor process variation. This contributes to both increased speed and improved yield rates.

As can be understood from the above explanation, the advantages of the invention are apparent in the fourth embodiment which integrates RISC processors on a chip. It is clear that the invention makes it possible to improve multiprocessor performance without reliance on processor architecture or logical unit structure modification.

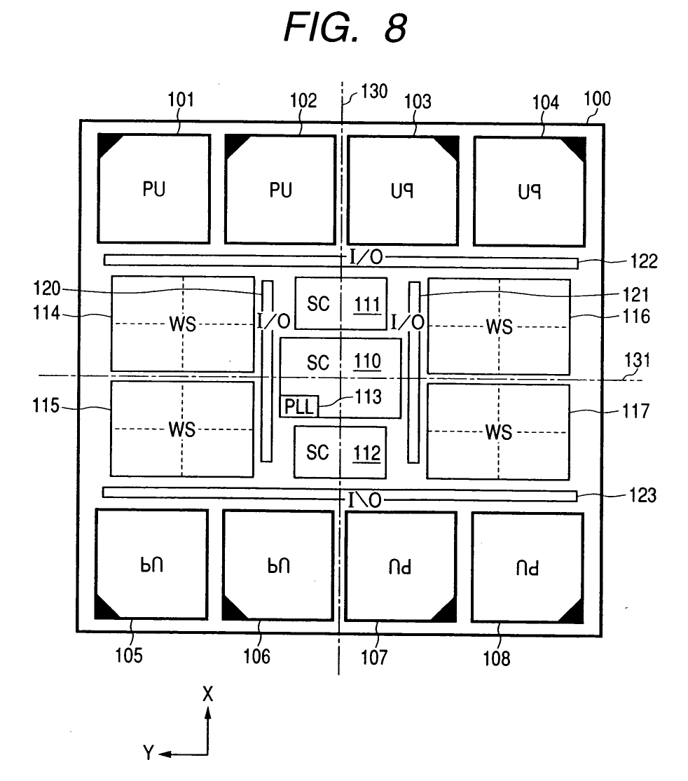

What is described next is the fifth embodiment of the invention for an on-chip multiprocessor having more than two processors on a chip, which is intended for use in more integrated chips that will emerge as the semiconductor process technology progresses. FIG. 8 is a floor plan for the fifth embodiment.

As shown in FIG. 8, an on-chip multiprocessor 100 is composed of eight processor units (PU) 101 to 108, storage units (SC) 110 to 112, work storages (WS, second caches) 114 to 117, internal striped array I/O pins (I/O) 120 to 123, and a clock generator (PLL) 113. The storage units SC110 to 112 are in charge of shared storage control for WS 114 to 117 and I/O interface control. This on-chip multiprocessor has been produced by the sub 0.1 μm generation CMOS technology, more advanced technology than that used in the first and third embodiments. A chip of approx. 23 mm square has PU1O1 to 108 including 8M transistors and 128 KB first caches, and WS114 to 117, which total 8MB, as well as approx. 1800 I/O pins. It runs at 1.5 GHz clock frequency. Situated in the left bottom of SC110 in the figure, PLL113 distributes clock signals via the clock driver at the intersection of linear axes 130 and 131 all over the inside of chip 100.

As clearly seen from FIG. 8, processor units PU1O1 to 108 are symmetric with respect to linear axes 130 and 131 (triangular markers indicate these symmetries). For example, concerning PU1O1, PU1O1 and PU104 are symmetric with respect to axis 130, PU1O1 and PU105 are symmetric with respect to 131 and PU1O1 and PU108 are point-symmetric with respect to the intersection of axes 130 and 131 (1800 rotation, double symmetric transformation with respect to axes 130 and 131).

Inside processor unit PU1O1, a controller for signal transmission from/to storage control units SC110 to 112 is provided at the bottom side of the unit (SC side) shown in the figure. According to the symmetric layout shown by this invention, the controllers inside PU102 to 108 are also located at the side nearer to the SCs. The controllers inside the PUs can be made nearer to SC110 to 112 than when they are randomly arranged. Also, work storages WS114 to 117 have equal distances to SC110 to 112 and so do I/0120 to 123.

Therefore, as in the first to fourth embodiments, according to this invention, multiprocessor control efficiency can also be effectively improved in the fifth embodiment which deals with a larger number of processors on a chip.

It is also obvious that even if the number of processors on a chip increases with advance in semiconductor process technology, this invention can be embodied by symmetric transformation on each pair of processors. Though PU101 to 108 are provided at the top and bottom sides of the chip in case of the fifth embodiment, it is possible to choose the arrangement pattern from among various options including striped, zigzag, checkered, matrix, cross and concentric patterns, depending on the multiprocessor connection type.

The X and Y axes in the left bottom of FIG. 8 represent the gate length direction and the gate width direction, respectively. In the fifth embodiment, the linear axis 130 corresponds to the gate length direction, which aims to give priority to uniformity in characteristics within each cluster of adjacent PUs (a cluster of 101-104 and a cluster of 105-108). To place, in a cluster of processors, more weight on some processors than on others instead of making all the processors run equally, the directions of the axes can be selected depending on the preference required.

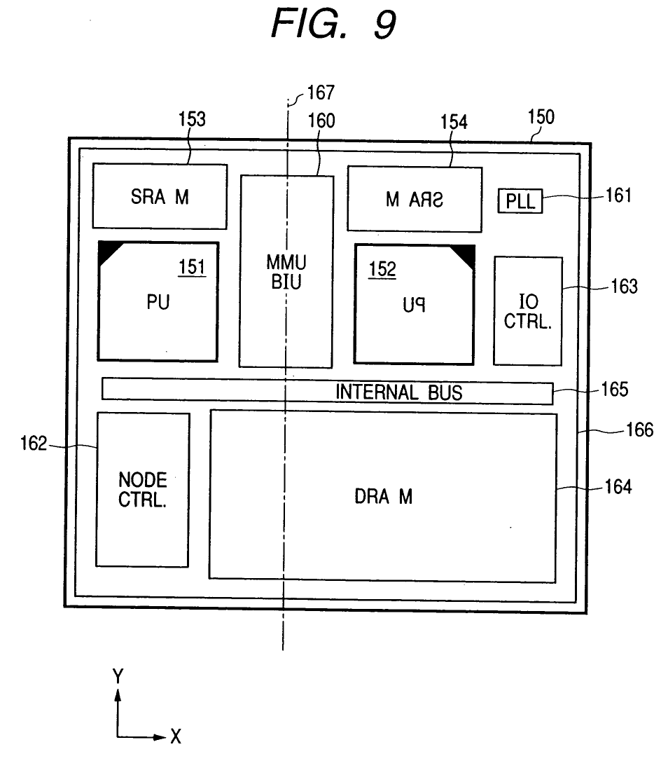

Shown in FIG. 9 as the sixth embodiment of the invention is an example of an application of this invention to less costly system LSIs, not to high-end custom LSIs for which the embodiments discussed so far are intended. This embodiment is different from the other embodiments in that symmetry is not pursued throughout the chip. However, the CPU core (PU) 151 and PU152 are symmetric with respect to the linear axis 167 and SRAM153 and 154 are symmetric with respect to the linear axis 167. Even the objects of the invention can be satisfactorily achieved in this form of embodiment.

As illustrated in the floor plan of FIG. 9, an on-chip multiprocessor 150 is composed of: two CPU cores (PU) 151 and 152; SRAM153 and 154 dedicated to PU151 and 152, respectively; a memory management unit (MMU) 160 also serving as an internal bus interface controller; a DRAM 164 serving as a main storage shared by PU151 and 152; a node control unit (NC) 162 for controlling network connections with other on-chip multiprocessors; an I/O control unit (I/O) 163 for controlling interfacing with input/output devices such as discs and channels; an internal bus 165 for connecting PUs, NC and IO units; a clock generator (PLL) 161; and peripheral I/O circuit array 166. In the sixth embodiment, PU151 and 152 in chip 50 constitute a shared storage system and, when connected with other chips by networking, also constitutes a distributed storage system.

In the sixth embodiment, PU51 and 152, SRAM macro 153 and 154, DRAM macro 164 and I/O macro 166 are implemented on a chip using system LSI component IP (intellectual property). Here, according to the invention, the supplied CPU core and SRAM macro IP are mirror-imaged. This means that PU151 and 152 are symmetric with respect to linear axis 167 and so are SRAM macro 153 and 154, and MMU160 is located in the area containing linear axis 167. The reason for the offset of linear axis 167 from the centerline is that the position of DRAM macro 164, a relatively large IP, and the wiring from NC162 or I/0163 to I/0166 have been taken into consideration. This offset does not affect the invention's advantages; on the contrary, this embodiment is successful in making PUs adjacent to MMU with equal distance. Therefore, in system LSIS, it is possible to solve the two problems of cost reduction and performance enhancement by symmetric transformation in IP layout according to this invention.

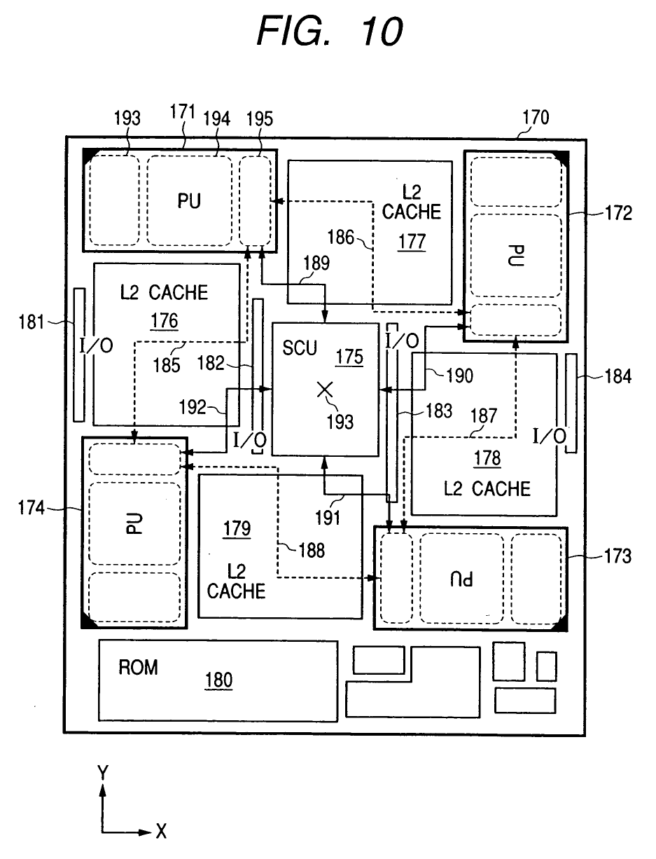

FIG. 10 is a floor plan for the seventh embodiment of the invention. While linear symmetry (symmetric transformation) or point symmetry (180° rotation) in chip layout has been discussed in the first to sixth embodiments, another type of symmetric transformation will be explained here.

As shown in FIG. 10, on-chip multiprocessor 170 is composed of four processor units (PU) 171 to 174, a storage control unit (SCU) 175, second caches 176 to 179, a ROM180, and striped I/O circuit arrays 181 to 184. PU171 consists of a processor core 194, a first cache 193 dedicated to PU171 and a bus interface control unit 195. The other PUs 172 to 74 have the same composition. The bus interface control unit in each PU controls the inter-PU ring bus connections as marked by arrows 185 to 188 in the figure and the PU-SCU interconnections as marked by arrows 189 to 192. SCU175 controls storages among PU171 to 174, shared second caches 176 to 179 and common I/O circuits 181 to 184 as well as the I/O interfacing.

The seventh embodiment uses the above-mentioned interconnection system for the purpose of distributing processing among the processor units to reduce concentration of the wiring to storage control unit SCU175 and decrease the number of wiring layers for chip 170. As clearly seen from FIG. 10, PU171 to 174 are rotated by 90 degrees with respect to the center of the chip as a virtual origin 193, and SCU175 lies in the area containing the origin 193. In this “windmill” arrangement, the distances from SCU175 ta four PUs, PU171 to 174, are equal, the distances from it to second caches 176 to 179 are equal as well, and the relay distances to adjacent PUs on the ring bus are also equal. This makes it possible to share the timing design among all these and prepare an optimum wiring system. Besides, since the wiring pattern for a single PU can be used for the three other PUs, leading to reduction in man-hours in wiring design work. The seventh embodiment, therefore, decreases the number of chip wiring layers or the chip manufacturing cost, reduces the required man-hours in design work and enables efficient multiprocessor control.

So far, layout examples of linear symmetry, point symmetry (180° rotation), and 90° rotation symmetry have been explained. However, as can be understood from the seventh embodiment, the effects of the invention cannot be decreased depending on the type of symmetric transformation. Even if any other type of symmetric transformation (for example, rotation at other angles, a combination of several symmetric transformations and translation, etc) is used, the advantages of the invention can be gained so long as the requirements for the invention are met.

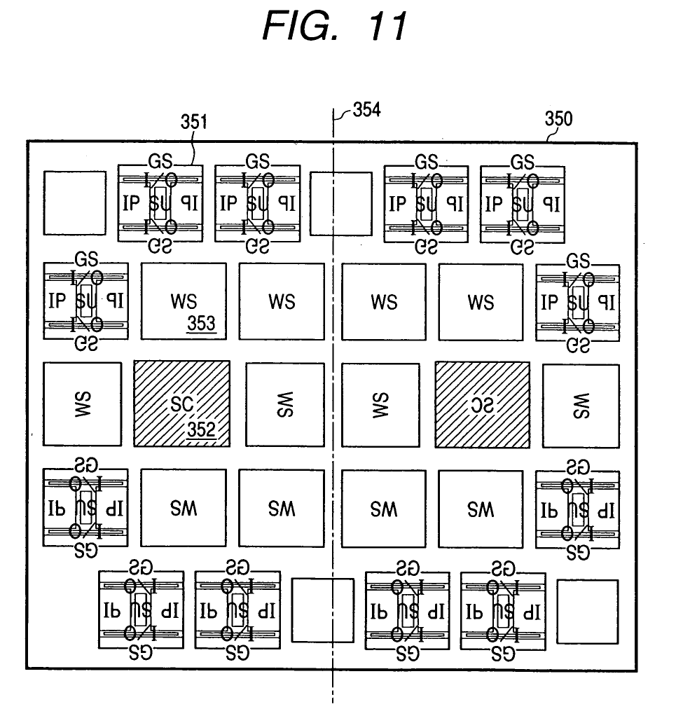

As the eighth embodiment, FIG. 11 shows an outline layout of a multi-chip module wiring board in which on-chip multiprocessors according to this invention are mounted. Here, the chip as discussed as the first embodiment is taken as an example.

The module wiring board 350 as shown in FIG. 11 consists of a thin or thick film ceramic combined multilayered substrate. Twelve dual processor chips (DP, the same as chip 1) 351, two storage control chips (SC) 352 and twelve work storage chips (WS, second caches) 353 are flip-chip bonded on the board 350. DPs, WSs and SCs are interconnected by multilayer wiring, constituting a 24-way multiprocessor system. SC352 is mainly responsible for controlling data transmission or access competition between processor chip 351 and WS353, and between WS353 and main storage (not shown in the figure) and synchronization in storage content between BS and CS inside chip 351.

The multiprocessor system according to the eighth embodiment can be divided into two clusters, a left-hand one and a right-hand one, with line 354 as a dividing line. The right-hand and left-hand chip arrangements and the wiring pattern of the board 350 are point-symmetric (1800 rotation). DPs, SCs and WSs are rotated by 90 degrees or 180 degrees, taking into consideration the arrangement of I/O pins (bumps) on each chip, the positional relationship with and wiring distance to other chips and the wiring concentration on the board 350. For each chip type, common I/O and power supply wiring patterns are used in a given wiring layer. The power supply wiring pattern beneath DPs is also shared since it reflects the symmetry of processors inside DP based on this invention, or the power supply wiring pattern and bump array symmetry inside the DP chip as shown in FIG. 6.

According to the eighth embodiment, therefore, a common design can be used in different wiring layers from the chip level to the entire substrate level, for design cost reduction. Furthermore, multiple processors on a chip can all run equally regardless of the chip position on the module, so high reliability in the whole system can be achieved.

As illustrated in the above-mentioned preferred embodiments, according to the first means of this invention, it is possible to shorten processor-controller transmission delays equally and reduce differences in controller-shared portions transmission delays by symmetric arrangement of multiple processors, multiprocessor controller and shared portions on a chip. Thus, efficient multiprocessor control can be realized and multiprocessor performance can be substantially improved in comparison with the prior art. The first means can be applied to different design levels from units through blocks, circuits and circuit cells down to transistors, depending on required performance and restrictive conditions imposed by semiconductor manufacturing technology and LSI packaging technology, so that the range of its application as a design technique is wide.

When symmetric transformation is made down to the transistor level, the introduction of a micro symmetric configuration can of f set characteristics fluctuations due to semiconductor process variation inside each transistor. This is effective in making the transistor characteristics uniform and improving yield rates. It is particularly suitable for clock circuits and RAM sense amplifiers which are vulnerable to characteristics fluctuations.

According to the second means of this invention, when symmetry with respect to a linear axis or point symmetry is introduced with a MOS transistor gate direction as a positioning reference, the gates inside the chip can be made parallel in a given direction and thus the influence of semiconductor process variation on transistor characteristics can be avoided. Also, in the second means, if the direction of data flow in data system logic is used as a positioning reference, data flows from the multiprocessor controller to multiple processors are parallel to each other without skews and delays, leading to further multiprocessor performance enhancement.

In producing on-chip multiprocessors incorporating highly reliable redundant dual processors, if not only processors but also dual units inside the processors are made symmetric with respect to linear axes, delays in the dual units can be made more uniform and shorter than in asymmetric layout, leading to uni-processor performance improvement. By making the symmetry axis for processors and that for dual units intersect at right angles, both the inter-processor distance and the distance between the dual units can be reduced, which improves both multiprocessor performance and uni-processor performance without any performance tradeoff.

According to the fourth means which defines a typical layout for multiprocessor controller and shared portions, storage control units and shared caches, I/O interface control units and I/O circuit groups, global clock generator, and power supply control circuitry are optimally positioned with respect to the multiprocessor. This has the effect of reducing fluctuations in basic characteristics such as delay, clock skew and power supply between processors. Also, the control speed can be further increased by optimizing the arrangement of first cache controllers and input/output controllers inside each processor.

According to the fifth means, when symmetric transformation is made on global patterns including clock trees, electric power supply wiring and I/O pins to follow the processor symmetry, clock skews and power supply characteristics can be made uniform and the required man-hours in timing design work and noise analyses can be decreased.

According to the sixth means, by producing a semiconductor process mask pattern for multiple processor areas by symmetric transformation, the man-hours required for the mask pattern production can be reduced.

According to the seventh means, symmetric transformation of wiring patterns for package boards, multi-chip module boards and the like ensures that the processors mounted on the chip can run equally, and reduces the number of man-hours required for wiring pattern production.

To summarize the above-mentioned features, the on-chip multiprocessor according to this invention offers the remarkable advantages of comprehensively improving both multiprocessor performance and uni-processor performance, stabilizing the basic characteristics of transistors, chips, packages and modules and reducing designing and manufacturing costs.

The effects of the invention can be universally demonstrated by means of layout symmetry of processors, controllers and shared portions; they cannot be restricted by device-technology including main frame/CISC/RISC processor architectures, logical division into units/blocks, data/control system logical structures, logical/memory circuit types, logical/memory circuit types (static CMOS, dynamic CMOS, BICMOS, bipolar) semiconductor processes, logical/circuit design tools and so on.

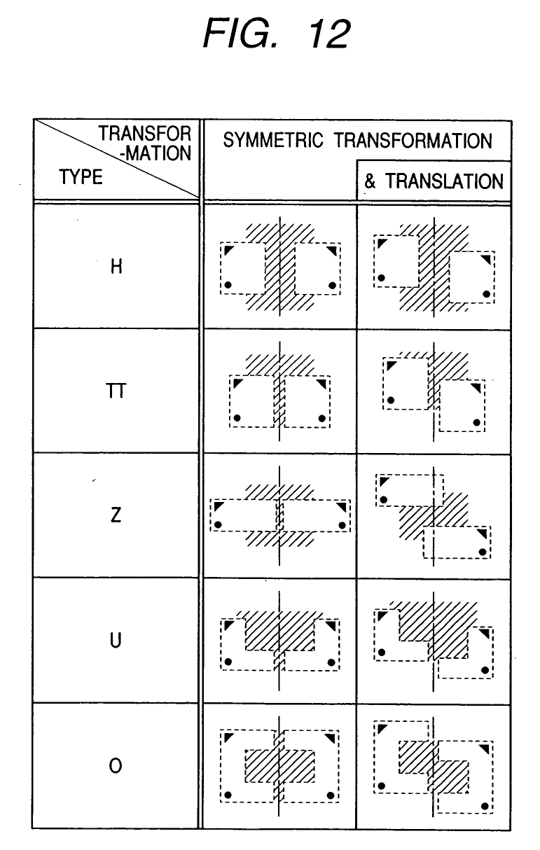

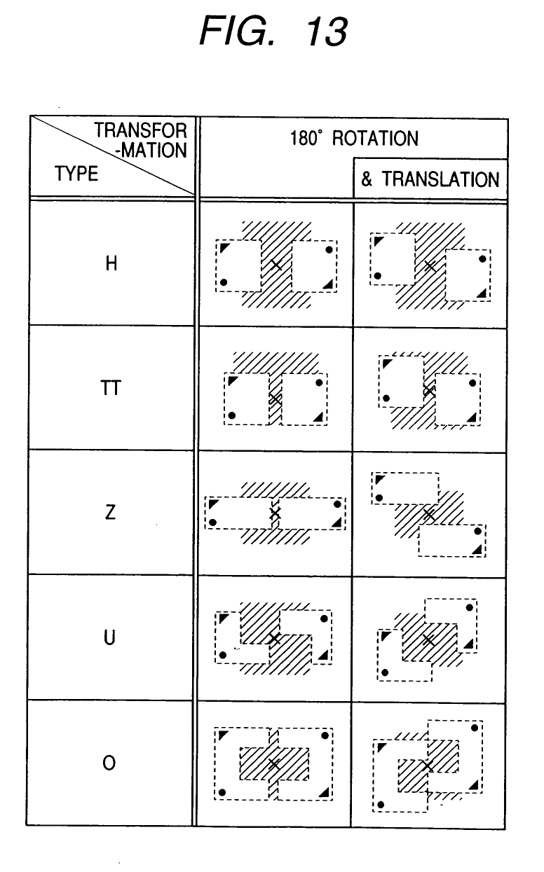

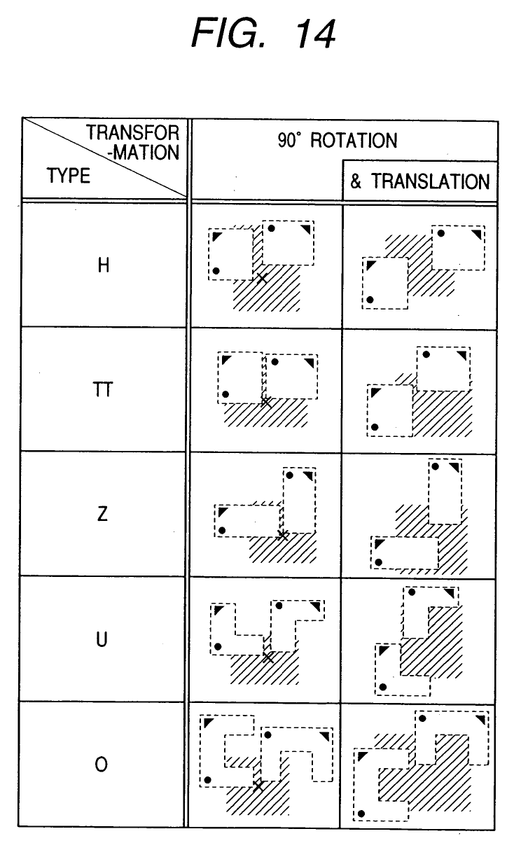

FIG. 12 shows an example of linear symmetry of blocks concerned, FIG. 13 shows an example of point symmetry (180° rotation), and FIG. 14 shows an example of 90° rotation. The framed areas denote the blocks to be made symmetric such as processors, and each framed area has a circle and a triangle in some of its corners to help the reader understand symmetric relationships between these blocks. Alternate long and short dash lines in the figure represent given virtual linear axes, X marks represent given virtual origins for rotation. In each figure, the hatched parts denote controllers and related components.

For each transformation type, translation of blocks (processors, etc) is also shown. This kind of translation also offers similar advantages. In the tables, various translation patterns are shown under the column entitled “& translation.” For translation, it is desirable that translation is made in the direction parallel to a given virtual linear axis in case of linear symmetric transformation and in the direction parallel to the opposite sides of the blocks in case of 180° and 90° rotation.

There are various types of floor plans for on-chip multiprocessor areas. Here, in the tables, H, Π, Z, U and O types are shown.

90° rotation is not adopted usually for an on-chip multiprocessor having two processors but it is useful for an on-chip multiprocessor having four processors. An example of 90° rotation in this type of multiprocessor has been given in FIG. 10.

As can be seen from FIGS. 12, 13 and 14, this invention can be embodied in various forms; variations in rotation angle and transistor direction other than those shown here are possible. In addition, whether the number of processors is either even or odd, the invention can be applied in various cases: overall or partial symmetric transformation, symmetric transformation in each division of the processor internal area, and change of positioning reference for each of the processors or processor divisions to be subject to transformation.

In this specification, on-chip multiprocessors having two or four processors have been given as examples, but even if an odd number of processors are provided, this invention is apparently applicable. Assuming that three processors are to be provided, as an example of the invention's first aspect, pairs from the three processors (for example, A and B, A and C) can be made symmetric to each other; as an example of its second aspect, only two processors (for example, A and B) may be made symmetric to each other and the other processor may be left intact. The basic concept of these forms is identical to that in partial application of the invention to the chip as shown in FIG. 9. The remaining processor as mentioned above may be used for another purpose or provided as a spare processor.

Lastly, let's compare the invention with the prior art.

Article 1 of the prior art is intended to reduce the number of I/O pins through a controller (data switch circuit) but does not pay attention to improvement in processor and controller speeds. The attached functional block diagram does not concretely show how processors are arranged on a chip. Even if functional blocks as shown in the diagram are implemented on the chip, the distances, or delay, from the processors to the controller may not be equal because of locally different input/output positions.

In Article 2 of the prior art as mentioned earlier, since multiple processors and multiple memory cell regions are connected via a single bus, it is necessary to provide bus interface controllers separately. Though the multiprocessor performance in this case depends on bus throughput, bus bandwidth expansion is not a good idea in terms of effective use of chip resources because it would increase overhead. Regarding the floor plan, all processors and memory regions are simply oriented in the same direction without giving consideration to the processor internal logical structure and memory region input/output positions. For this reason, Article 2 is not suitable for high performance multiprocessors which this invention is intended for.

In Article 3 as mentioned earlier, two processor chips are networked to make up a distributed storage system, with I/O pins on the two chips connected through shared external bus. Therefore, each processor should be provided with distributed memory, a network interface controller and an external bus interface controller. In other words, an on-chip multiprocessor based on the prior art of Article 3 does not lead to economic use of chip resources. If the layout designed for two chips is used for one chip instead, efficient multiprocessor control could not be achieved because of failure to preserve layout integrity.

In a single processor as mentioned earlier in Article 4, dual units (IU, FXU, FPU) are mirrored with respect to the halving line of the chip and non-dual units (BCE, RU) lie on the halving line. This arrangement makes the distances and delays between the dual and non-dual units uniform and improves control efficiency. However, Article 4 discloses a technique for single processors and does not offer clues to on-chip multiprocessor layout associated with processors, controller and shared portions on a chip. Even if the technique disclosed in Article 4 is used for multiprocessors, no suggestion is given as to what kind of processor pattern is used (simple translation, linear symmetry, point symmetry, rotation or combination of these) in which direction to orient the processors at the four sides of the chip, and where to place the controller and shared portions in relation to the processors. This is why a new idea for on-chip multiprocessor technology is necessary.

This invention makes it possible to perform efficient multiprocessor control while ensuring that multiple processors can run independently and equally. It speeds up processor-controller data transmission, arbitration control and other related operations in a balanced way for the processors.

Next, the effects of various concrete means are summarized.

If multiple processors, multiprocessor controller and shared portions are symmetrically arranged using the first means of this invention, delays between the processors and controller can be decreased equally and differences in delay of transmission between the controller and shared portions can be reduced.

When symmetric transformation is made down to the transistor level, characteristics fluctuations due to semiconductor process variation can be offset by introducing a micro symmetric structure into MOS transistors.

By adopting linear symmetric transformation or 180° rotation in chip layout with a MOS transistor gate direction as a positioning reference according to the second means of the invention, the gates on the chip can be made parallel to each other in a given direction, and thus the influence of semiconductor process variation on transistor characteristics can be avoided.

According to the third means of the invention, by adopting linear symmetric transformation for not only the processors but also the dual units inside each processor, delays in the dual units can be made more equal and shorter than when asymmetric layout is adopted for them, thereby enhancing processor performance.

According to the fourth means which defines a typical layout with multiprocessor controller and shared portions, storage control units, shared caches, I/O interface control units, I/O circuit groups, global clock generator and power supply control circuitry are optimally positioned with respect to the multiprocessor.

According to the fifth means, when symmetric transformation is made on global patterns including clock trees, electric power supply wiring and I/O pins to follow the processor symmetry, clock skew and power supply characteristics can be made uniform.

According to the sixth means, by producing a semiconductor process mask pattern for multiple processor areas by symmetric transformation, man-hours required for the mask pattern production can be reduced.

According to the seventh means, symmetric transformation of wiring patterns of package boards, multi-chip module boards and the like also ensures that the processors mounted on the chip can run equally, and reduces the number of man-hours required for wiring pattern generation.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

What is claimed is

1. An on-chip multiprocessor having multiple independently operable processors mounted on an integrated circuit chip, wherein at least one pair of processors among said processors are positioned symmetrically each other with respect to a given linear axis or a given origin in the plane of the chip.

2. An on-chip multiprocessor having multiple independently operable processors mounted on an integrated circuit chip, wherein at least one pair of processors among said processors are positioned symmetrically each other with respect to a given linear axis or a given origin in the plane of the chip and the controller for said pair of processors is located in the area containing said linear axis or origin.

3. The on-chip multiprocessor as disclosed in claim 2, wherein delays between each processor of said pair and said controller are almost equal.

4. An on-chip multiprocessor having multiple independently operable processors mounted on an integrated circuit chip, wherein: at least one pair of processors among said processors are positioned symmetrically each other with respect to a given linear axis or a given origin in the plane of the chip; delays in transmission between said multiprocessor controller and each processor of said pair of processors are almost equal; and the shared portions connected through the controller to said pair of processors are located in the area containing said linear axis or origin.

5. An on-chip multiprocessor having multiple independently operable processors mounted on an integrated circuit chip, wherein at least one pair of processors among said processors are situated at positions shifted from positions symmetric with respect to a given linear axis or a given origin in the plane of the chip, in a direction parallel to said axis or the centerline of the area of said pair.

6. An on-chip multiprocessor having multiple independently operable processors mounted on an integrated circuit chip, wherein: at least one pair of processors among said processors are situated at positions shifted from positions symmetric with respect to a given linear axis or a given origin in the plane of the chip, in a direction parallel to said axis or the centerline of the area of said pair; and the controller for said pair of processors is located in the area containing said linear axis or origin.

7. An on-chip multiprocessor wherein delays in transmission from each processor of said pair of processors to said controller are almost equal.

8. An on-chip multiprocessor having multiple independently operable processors mounted on an integrated circuit chip, wherein: at least one pair of processors among said processors are situated at positions shifted from positions symmetric with respect to a given linear axis or a given origin in the plane of the chip, in a direction parallel to said axis or the centerline of the area of said pair; delays in transmission between said controller and each processor of said pair of processors are almost equal; and the shared portions connected through said controller to said pair of processors are located in the area containing said linear axis or origin.

9. The on-chip multiprocessor as defined in claim 1, wherein said processors have logical units and cache memories, and in said pair of processors, two logical units or cache memories with the same function as a pair are symmetric each other with respect to said linear axis or origin.

10. The on-chip multiprocessor as defined in claim 9, wherein said logical units and cache memories have each logical blocks and memory mats, and in said pair of processors, two logical blocks or memory mats with the same function as a pair are symmetric each other with respect to said linear axis or origin.

11. The on-chip multiprocessor as defined in claim 9, wherein said logical blocks and memory mats have each logical circuit groups and memory circuit groups, and in said pair of processors, two logical circuit groups or memory circuit groups with the same function as a pair are symmetric each other with respect to said linear axis or origin.

12. The on-chip multiprocessor as defined in claim 9, wherein said logical circuit groups and memory circuit groups consist of MOS transistor circuits, and sources, gates and drains inside said circuit groups or p-MOS and n-MOS transistors are symmetric each other with respect to said linear axis or origin.

13. The on-chip multiprocessor as defined in claim 12, wherein at least some of the MOS transistors in said pair of processors have one gate and a source and drain at one side of the gate, a drain and a source, opposite to said source and drain, at the other side of the gate, and also have two gates through which a same signal is inputted, one drain between the gates, and two sources outside the gates.

14. The on-chip multiprocessor as defined in claim 1, wherein said processors comprise MOS transistor circuits, and said pair of processors are mirror-symmetric with respect to a linear axis parallel or perpendicular to the MOS transistor gate, or point-symmetric (180° rotation) with respect to said origin.

15. The on-chip multiprocessor as defined in claim 9, wherein said pair of processors are symmetric with respect to a linear axis parallel or perpendicular to the direction of data flow in said logical units, or point-symmetric (180° rotation) with respect to said origin.

16. An on-chip multiprocessor having multiple independently operable processors and their processor mounted on an integrated circuit chip, wherein: some of the logical units or cache memories constituting each processor are dual and redundant; in at least one pair of processors, two logical units or cache memories with the same function as a pair are symmetric each other with respect to a given first linear axis in the chip plane; the controller for said pair of processors is located in the area containing the first linear axis; the distances from said controller to both the processors are almost equal; and two logical units or cache memories as a dual unit included in each processor are symmetric each other with respect to a given second linear axis.

17. The on-chip multiprocessor as defined in claim 16, wherein said first linear axis and second linear axis intersect at right angles.

18. The on-chip multiprocessor as defined in claim 16, wherein said processors comprise MOS transistor circuits, and said first linear axis is parallel to the MOS transistor gate width direction and said second linear axis is parallel to the MOS transistor gate length direction.

19. The on-chip multiprocessor as defined in claim 16, wherein said first linear axis is perpendicular to the direction of data flow in said logical units and said second linear axis is parallel to the direction of data flow.

20. The on-chip multiprocessor as defined in claim 2, wherein: said pair of processors also have cache memory shared by them, and storage control unit for controlling processing of signals between said shared cache memory and said pair of processors; and said shared cache memory and storage control unit are located in said area.

21. The on-chip multiprocessor as defined in claim 2, wherein said pair of processors also share I/O circuit group, and storage control unit for controlling signal transmission between said I/O circuit group and said pair of processors is located in said area.

22. The on-chip multiprocessor as defined in claim 4, wherein a clock generator, which supplies clock signals in common or separately to said pair of processors, said controller and said shared portions, is located in said area.

23. The on-chip multiprocessor as defined in claim 4, wherein a power supply control circuit, which supplies electric power in common or separately to said pair of processors, said controller and said shared portions, is located in said area.

24. The on-chip multiprocessor as defined in claim 1, wherein: each of said processors has first cache memory and a first cache memory control unit for controlling it; multiple processors share lower level cache memory through its control unit; in said pair of processors, the first cache control units are located beside one side of each processor area nearer to said linear axis or origin; and the lower level cache control unit is located between the first cache control units as a pair.

25. The on-chip multiprocessor as defined in claim 1, wherein: each of said processors has a first control unit for controlling its input/output signals; multiple processors share I/O circuit group through a second control unit; in said pair of processors, the first control units are located beside one side of each processor area nearer to said linear axis or origin; and the second control unit is located between the first control units as a pair.

26. The on-chip multiprocessor as defined in claim 1, wherein the pattern of clock trees which distribute clock signals to said pair of processors is symmetric with respect to said linear axis or origin.

27. The on-chip multiprocessor as defined in claim 1, wherein the pattern of power supply wiring which supplies electric power to said pair of processors is symmetric with respect to said linear axis or origin.

28. The on-chip multiprocessor as defined in claim 1, wherein the I/O pins of said processors consist of bump arrays and the arrangement of bumps on the surfaces of said pair of processors is symmetric with respect to said linear axis or origin.

29. The on-chip multiprocessor as defined in claim 1, wherein one processor in said pair of processors is manufactured using semiconductor mask pattern 1 and the other is manufactured using semiconductor mask pattern 2.

30. A circuit board wherein the on-chip multiprocessor as defined in claim 1 is mounted, wiring pattern 1 for one processor in said pair of processors and wiring pattern 2 for the other processor are symmetric each other with respect to a given linear axis on the circuit board or said origin.
